(19) United States
(12) Patent Application Publication
(10) Pub. No.: US 2011/0170022 A1
(43) Pub. Date: Jul. 14, 2011

(54) ILLUMINATION DEVICE AND LIQUID CRYSTAL DISPLAY DEVICE

(75) Inventor: Kaori Ikuta, Osaka-shi (JP)

(73) Assignee: SHARP KABUSHIKI KAISHA, Osaka-shi, Osaka (JP)

(21) Appl. No.: 13/120,731

(22) PCT Filed: May 26, 2009
(86) PCT No.: PCT/JP2009/059594

§ 371 Date: Mar. 24, 2011

(30) Foreign Application Priority Data
Oct. 2, 2008 (JP) 2008-257532

(51) Int. Cl. G02F 1/13357; F21V 8/00; H04N 3/14

(52) U.S. Cl. 348/790; 362/616; 349/65; 348/E03.016

(57) ABSTRACT

A backlight (2) of the present invention includes a light source (5), a plurality of light guides (7) and (17) for emitting light emitted from the light source (5), and a reflecting material (6), which is disposed so as to face surfaces of the plurality of light guides (7) and (17) which surfaces are opposite to light emission surfaces (7a) of the plurality of light guides (7) and (17). The light guide (7) and the light guide (17) are adjacent to each other. The reflecting material (6) includes a protruding section (20) having a curved surface in a region on that surface of the reflecting material (6) which faces the light guides (7) and (17), which region corresponds to a region between the light guide (7) and the light guide (17). The arrangement makes it possible to realize an illumination device having further improved uniformity of luminance.

### TECHNICAL FIELD

The present invention relates to (i) an illumination device to be used as a backlight of a liquid crystal display device; and (ii) a liquid crystal display device including the illumination device.

### BACKGROUND ART

Liquid crystal display devices are being widely used in liquid crystal televisions, monitors, mobile phones, and the like devices, by taking advantage of characteristics thereof such as energy saving, a flat shape, and lightweight. In order to further take advantage of these characteristics, it is necessary, for example, to improve an illumination device, i.e., what is called a backlight, which is provided on a back of a liquid crystal display device.

Illumination devices are roughly classified into the following main types, a sidelight type (also called an edge light type) and a direct type. The sidelight type has such an arrangement that a light guide is provided on a back of a liquid crystal display panel, and a light source is provided at a lateral end of the light guide. Light emitted from the light source reflects off the light guide so that the liquid crystal display panel is indirectly irradiated with the light uniformly. The arrangement realizes an illumination device that is flat and excellent in luminance uniformity, though luminance is low. In view of this, such an illumination device of the sidelight type is employed mainly in medium and small size liquid crystal displays such as mobile phones, notebook computers, and the like.

One example of the illumination device of the sidelight type is a plane-emission device disclosed in Patent Literature 1. Patent Literature 1 discloses a plane-emission device in which a plurality of dots are formed on a reflection surface of a light-guiding plate so that light can be uniformly emitted from a light emission surface. In the plane-emission device, the dots are formed thicker in corner portions of the reflection surface than in other portions thereof because the corner portions tend to receive less light and therefore to become shadowy, due to the directivity of the light source.

On the other hand, an illumination device of the direct type is arranged such that a plurality of light sources are provided on a back of a liquid crystal display panel so that the liquid crystal display panel receives light directly from the plurality of light sources. Therefore, the illumination device of the direct type can easily have high luminance even if the illumination device has a large screen. In view of this, the illumination device of the direct type is mainly employed in large size liquid crystal displays having a size of at least 20 inches. However, the illumination devices of the direct type currently used have a thickness of about 20 mm to 40 mm. That is, the arrangement of the direct type prevents further reduction in thickness of displays.

The further reduction in thickness of such a large size liquid crystal display would be achievable by placing the light source and the liquid crystal display panel closer. In this case, the number of light sources should be increased so as to obtain uniformity of luminance in the illumination device. However, the increase in the number of light sources leads to an increase in cost. In view of this, development of flat illumination devices which are excellent in uniformity of luminance and which can be produced without increasing the number of light sources are desired.

In order to solve these problems, such an attempt has been conventionally conducted that a plurality of illumination devices of the sidelight type are aligned so as to reduce the thickness of a large size liquid crystal display.

For example, Patent Literature 2 discloses a surface light source device that has a compact structure to secure a large light-emission area. The surface light source device of Patent Literature 2 is preferably usable in a large size liquid crystal display. The surface light source device has a tandem structure including plate-like light guiding blocks aligned in a tandem manner, and primary light sources for providing primary light to the respective light guiding blocks. An illumination device in which a plurality of light-emitting units each including a combination of a light source and a light guide are provided in a tandem manner as such is called a tandem-type illumination device. Further, Patent Literature 2 discloses a tandem-type surface light source device in which a plurality of tandem-type light guiding—light emitting mechanisms are provided in parallel. In this arrangement, light guiding blocks and light sources for providing primary light to the respective light guiding blocks are aligned extensively, thereby making it possible to provide a tandem-type surface light source device having a very large light-emission area.

### Citation List

Patent Literature 1
Japanese Patent Application Publication, Tokukai, No. 2003-43266 A (Publication Date: Feb. 13, 2003)
Patent Literature 2
Japanese Patent Application Publication, Tokukaihei, No. 11-288611 A (Publication Date: Oct. 19, 1999)
Patent Literature 3
Japanese Patent Application Publication, Tokukai, No. 2007-206398 A (Publication Date: Aug. 16, 2007)

### SUMMARY OF INVENTION

However, in the tandem-type surface light source device disclosed in Patent Literature 2, light entering the light guide from the light source mainly travels in a direction parallel to the tandem alignment. Therefore, in a case where the tandem-type light guiding—light emitting mechanisms are arranged in parallel, the light does not reach so much regions between the tandem-type light guiding—light emitting mechanisms thus arranged in parallel, thereby decreasing luminance in these regions. Accordingly, luminance unevenness is caused, which renders uniformity of luminance impaired.

Patent Literature 3 discloses a technique for restraining a decrease in luminance caused at boundaries between a plurality of light guiding blocks in a direct-type surface light source device, in which the plurality of light guiding blocks are provided in combination. However, this device requires processing to form the light guiding blocks in complicated shapes. Therefore, it is impossible to maintain uniformity of luminance by using conventional light guides as they are.

The present invention is accomplished in view of the above problems. An object of the present invention is to provide an illumination device constituted by a plurality of light guides, which illumination device has improved uniformity of luminance.

In order to achieve the above object, an illumination device according to the present invention includes: a light source; a plurality of light guides for receiving light emitted from the light source and for emitting the light in a plane manner; and a reflecting member, which is disposed so as to face surfaces of the plurality of light guides which surfaces are opposite to light emission surfaces of the plurality of light guides, and the illumination device according to the present invention is arranged such that among the plurality of light guides, a first light guide and a second light guide are adjacent to each other, and the reflecting member includes at least one protruding section having a curved surface in a region on that surface of the reflecting member which faces the plurality of light guides, which region corresponds to a region between the first light guide and the second light guide when viewed in a projection manner along a normal direction of the light emission surfaces.

In the above arrangement, part of light emitted to the region between the first light guide and the second light guide adjacent to each other is incident on the reflecting member, on which the light is scattered. The light thus incident on the curved surface of the protruding section provided in the reflecting member is changed in its outgoing direction, so that less light returns into the light guides. Accordingly, a more amount of the light travels toward the same direction as light emitted through the light emission surfaces of the light guides. This increases luminance between the adjacent light guides, thereby restraining an occurrence of luminance unevenness, which is caused due to darkening at a center of the region between the adjacent light guides. Consequently, the arrangement makes it possible to realize an illumination device having further improved luminance uniformity.

That a protruding section is provided in a region corresponding to the region between the light guides when viewed in a projection manner along a normal direction of the light emission surfaces indicates not only that the entire protruding section is arranged in the region corresponding to the region between the light guides, but also that the protruding section is partially arranged in the region corresponding to the region between the light guides.

In the illumination device according to the present invention, it is preferable that the first light guide and the second light guide be adjacent to each other in a direction which is vertical to an optical axis direction of the light emitted from the light source and which is parallel to the light emission surfaces.

Most of the light emitted from the light source is guided, in the light guides, into a direction parallel to the optical axis direction. That is, an amount of light that is guided in a direction which is vertical to the optical axis direction and which is parallel to the light emission surfaces is relatively small. Therefore, luminance is lower in the region between the light guides adjacent to each other along this direction than in the other regions. For this reason, this region largely affects the uniformity of luminance.

In this regard, in the above arrangement, the reflecting member includes a protruding section having a curved surface in a region corresponding to the region between the light guides adjacent to each other in a direction which is vertical to the optical axis direction and which is parallel to the light emission surfaces. This makes it possible to restrain a decrease in luminance in this region. As a result, the arrangement makes it possible to improve the luminance uniformity more effectively to prevent the decrease in luminance in a region in which the decrease in luminance occurs more notably.

Here, the optical axis direction of the light emitted from the light source indicates a direction (oriented direction) of a main component of the light emitted from the light source with directivity. In other words, the optical axis direction of the light emitted from the light source indicates a direction (light-guiding direction) to which light entering the light guide is mainly guided.

In the illumination device according to the present invention, it is preferable that a surface of the at least one protruding section is curved.

With the above arrangement, light incident on the protruding section is all scattered. This makes it possible to prevent the decrease in luminance between the adjacent light guides more effectively, thereby realizing an illumination device having more improved luminance uniformity.

In the illumination device according to the present invention, it is preferable that the at least one protruding section be a band-like protruding section extending in parallel with an optical axis direction of the light emitted from the light source.

With the above arrangement, it is possible to cause light scattering in a large part of the region between the adjacent light guides, thereby making it possible to prevent the decrease in luminance between the light guides more effectively.

Further, in the illumination device according to the present invention, it is preferable that the at least one protruding section have an arc-shaped contour when viewed in a cross section perpendicular to an optical axis direction of the light emitted from the light source.

In the illumination device according to the present invention, the at least one protruding section may include a plurality of protruding sections.

With the above arrangement, it is possible to adjust a degree of the light scattering by adjusting the number of protruding sections to be formed. This makes it possible to adjust how much the luminance is to be increased, in conformity to how low the luminance between the light guides is. Thus, it is possible to improve luminance uniformity effectively.

In the illumination device according to the present invention, it is preferable that the plurality of light guides and the reflecting member be spaced apart to form a gap therebetween.

Further, a liquid crystal display device according to the present invention includes, as a backlight, any one of the illumination devices according to the present invention.

In the above arrangement, the liquid crystal display device includes an illumination device according to the present invention. This makes it possible to realize a liquid crystal display device excellent in uniformity of luminance.

Further, a television device according to the present invention includes a liquid crystal display device according to the present invention.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a cross-sectional view illustrating an arrangement of a liquid crystal display device according to one embodiment of the present invention.

FIG. 2 is a top view illustrating an arrangement of a backlight according to one embodiment of the present invention.

FIG. 3 is a cross-sectional view illustrating the backlight, viewed along arrows A-A′ of FIG. 2. FIG. 3 schematically illustrates light-traveling directions.

FIG. 4 is a cross-sectional view illustrating a backlight according to another embodiment of the present invention. FIG. 4 schematically illustrates light-traveling directions.

FIG. 5 is a cross-sectional view illustrating a backlight according to further another embodiment of the present invention. FIG. 5 schematically illustrates light-traveling directions.

FIG. 6 is a perspective view illustrating a reflecting material according to another embodiment of the present invention.

FIG. 7 illustrates light-emitting directions of light scattered on a reflecting material: (a) of FIG. 7 illustrates a case where a conventional reflecting material is used; and (b) of FIG. 7 illustrates a case where a reflecting material for use in the present invention is used.

FIG. 8 illustrates a conventional backlight: (a) of FIG. 8 is a top view thereof; and (b) of FIG. 8 is a cross-sectional view illustrating the conventional backlight, viewed along arrows B-B′, and schematically illustrates light-traveling directions.

FIG. 9 is an exploded perspective view illustrating a television device according to one embodiment of the present invention.

### DESCRIPTION OF EMBODIMENTS

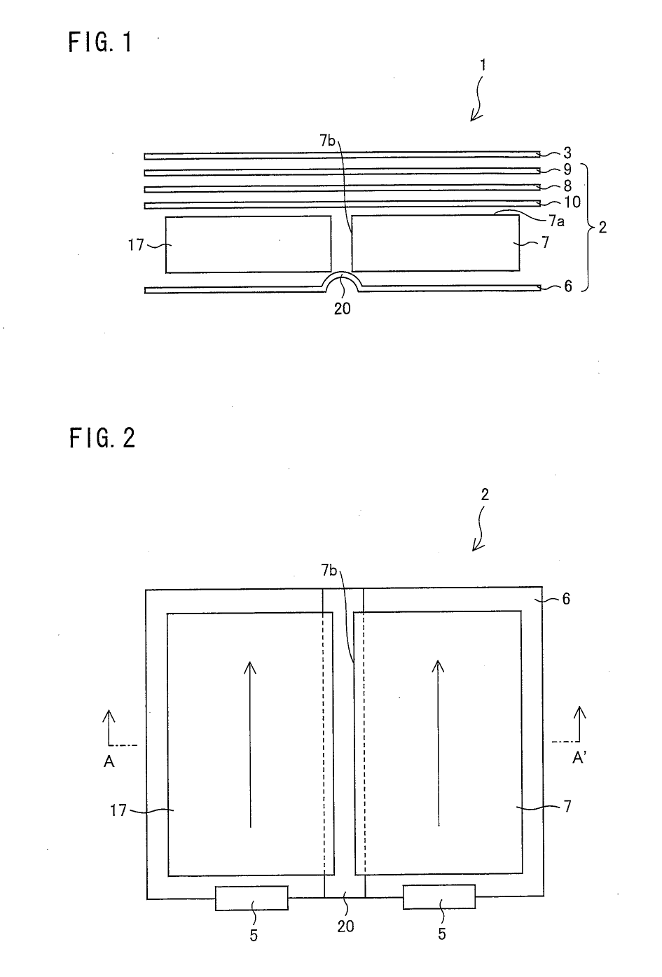

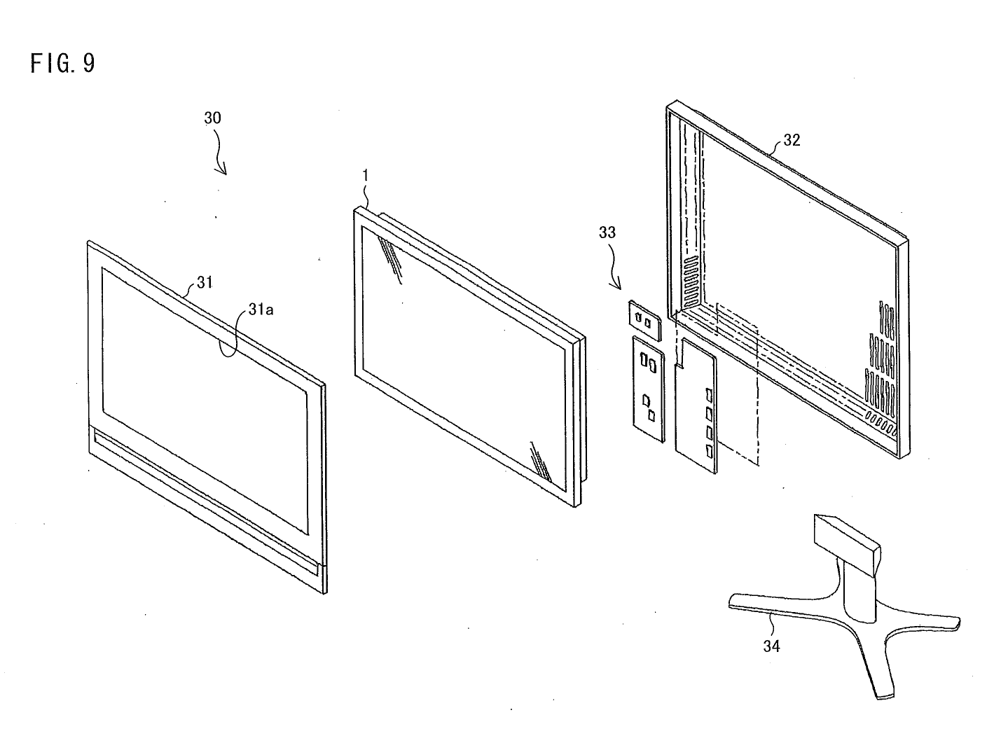

One embodiment of the present invention is described below with reference to FIG. 1 to FIG. 5, and FIG. 9. The present invention is not limited to the following embodiment.

[Liquid Crystal Display Device]

The present embodiment deals with an illumination device to be used as a backlight of a liquid crystal display device.

FIG. 1 is a cross-sectional view schematically illustrating an arrangement of a liquid crystal display device 1 according to the present embodiment. The liquid crystal display device 1 includes a backlight 2 (illumination device), and a liquid crystal display panel 3 provided so as to face the backlight 2.

The liquid crystal display panel 3 is a general liquid crystal display panel for use in a conventional liquid crystal display device. Though not shown in figures, the liquid crystal display panel 3 includes, for example: an active matrix substrate in which a plurality of TFTs (Thin Film Transistor) are provided; a CF substrate opposed to the active matrix substrate; and a liquid crystal layer provided between these substrates and sealed by a seal material.

The following describes an arrangement of the backlight 2 provided in the liquid crystal display device

The backlight 2 is disposed on a back of the liquid crystal display panel 3, i.e., a side, of the liquid crystal panel 3, opposite to a display surface thereof. As illustrated in FIG. 1, the backlight 2 is provided with light sources 5 (not shown), a reflecting material 6 (reflecting member), a light guide 7, a diffusing plate 8, an optical sheet 9, and a transparent plate 10. The backlight 2 is constituted by at least two light guides. The present embodiment deals with a backlight 2 in which two light guides, 7 and 17, are arranged in parallel. If not otherwise specified, the following description takes the light guide 7 out of the light guides 7 and 17, as a typified example. In FIG. 1 to FIG. 5, which describes the present embodiment, the size of each member and the distance between the light guide 7 and the light guide 17 are overdrawn for convenience of explanation.

FIG. 2 is a top view of the backlight 2, viewed from the top (a side where the liquid crystal display panel is placed). In FIG. 2, the diffusing plate 8, the optical sheet 9, and the transparent plate 10 are not shown for convenience of explanation. The light source 5 is disposed so as to face one surface of the light guide 7. A protruding section 20 is provided so as to extend in a band-like form along a normal direction of that surface of the light guide 7 which the light source 5 faces, that is, along an optical axis direction.

The light source 5 is a sidelight-type light-emitting diode (LED), a cold-cathode tube (CCFL), or the like, for example. The present embodiment deals with an LED as an example of the light source 5. By using, as the light source 5, a sidelight-type LED in which respective chips for R, G, and B are molded as a single package, it is possible to obtain an illumination device that can realize color reproduction in a wide range. The light source 5 is provided on a substrate (not shown).

The light guide 7 causes light received from the light source 5 to be emitted from a light emission surface (also referred to as light output surface) 7a in a plane manner. The light emission surface 7a is a surface from which to emit light toward an irradiation subject. The light emission surface 7a of the light guide 7 or its opposite surface of the light guide 7 is processed and treated so that the light emission surface 7a or the back surface emits light guided therein toward a front side. The light is accordingly emitted from the light emission surface 7a of the light guide 7 toward a side of the liquid crystal display panel 3. More specifically, the processing and the treatment performed on a light-guiding portion of the light guide 7 may be, for example, prism processing, surface texturing, and a printing process. However, the processing and the treatment are not limited to them, and a well-known method can be used as appropriate.

The light guide 7 is mainly made from transparent resin, such as polycarbonate (PC), polymethylmethacrylate (PMMA), or the like. However, the material of the light guide 7 is not especially limited, and is preferably a material having high optical transmittance. Further, the light guide 7 can be formed by molding, such as injection molding, extrusion molding, heat-press molding, or a cutting process. The molding method is not limited particularly, and any processing method that exercises similar characteristics can be used.

The reflecting material 6 is disposed so as to face a backside of the light guide 7 (an opposite side to the light emission surface 7a). The reflecting material 6 and the light guide 7 are spaced apart to form a gap therebetween, that is, they are distanced from each other at a predetermined interval. The reflecting material 6 reflects light emitted from the light guide 7 toward the reflecting material 6, so that more light can be emitted through the light emission surface 7a. The reflecting material 6 is made from resin such as foamed PET (polyethylene terephthalate), PC (polycarbonate), or PS (polystyrene), and has a surface on which a metal thin film having high reflectance, such as silver or aluminum, is deposited. The material of the reflecting material 6 is not limited to the above materials, provided that the reflecting material 6 can maintain its shape after being formed. The material of the reflecting material 6 is preferably foamed PET. The reflecting material 6 can be formed by molding, for example, injection molding, extrusion molding, heat-press molding, or a cutting process.

The reflecting material 6 is subjected to such a surface-treatment that microscopic concavities and convexities are formed so that a surface of the reflecting material 6 is matte. This allows the reflecting material 6 to scatter light incident on the reflecting material 6.

The diffusing plate 8 is provided facing the light emission surface 7a so as to entirely cover a planar light emission surface constituted by the light emission surfaces 7a of each of the light guides 7 and 17. The diffusing plate 8 diffuses the light emitted through the light emission surface 7a of the light guide 7, and outputs the light toward the optical sheet 9.

The optical sheet 9, which is constituted by a plurality of sheets provided in layers, uniformizes and collects the light emitted through the light emission surface 7a of the light guide 7, and then outputs the light toward the liquid crystal display panel 3. That is, examples of the optical sheet 9 to be used may be, for example: a diffusing sheet for collecting and diffusing light; a lens sheet for collecting light to improve luminance in a front direction (a direction toward the liquid crystal display panel); and a polarized-light reflecting sheet for reflecting one of polarized-light components of light while passing the other one therethrough so as to improve the luminance of the liquid crystal display device 1. It is preferable that these sheets be used in combination appropriately depending on price and performance of the liquid crystal display device 1.

The transparent plate 10 is used to keep constant the distance between the light guide 7 and the diffusing plate 8, and forms a light-diffusing area. The transparent plate 10 is made from a translucent material such as a polyethylene film. The liquid crystal display device 1 may be arranged such that the transparent plate 10 is omitted and the light guide 7 and the diffusing plate 8 are disposed so as to face each other.

With the aforementioned arrangements of the respective members, light emitted from the light source 5 travels through the light guide 7 while being subjected to a scattering effect and a reflecting effect. The light is then emitted through the light emission surface 7a, passes through the diffusing plate 8 and the optical sheet 9, and finally reaches the liquid crystal display panel 3.

[Uniformity of Luminance]

The following describes a principle of how the luminance becomes uneven.

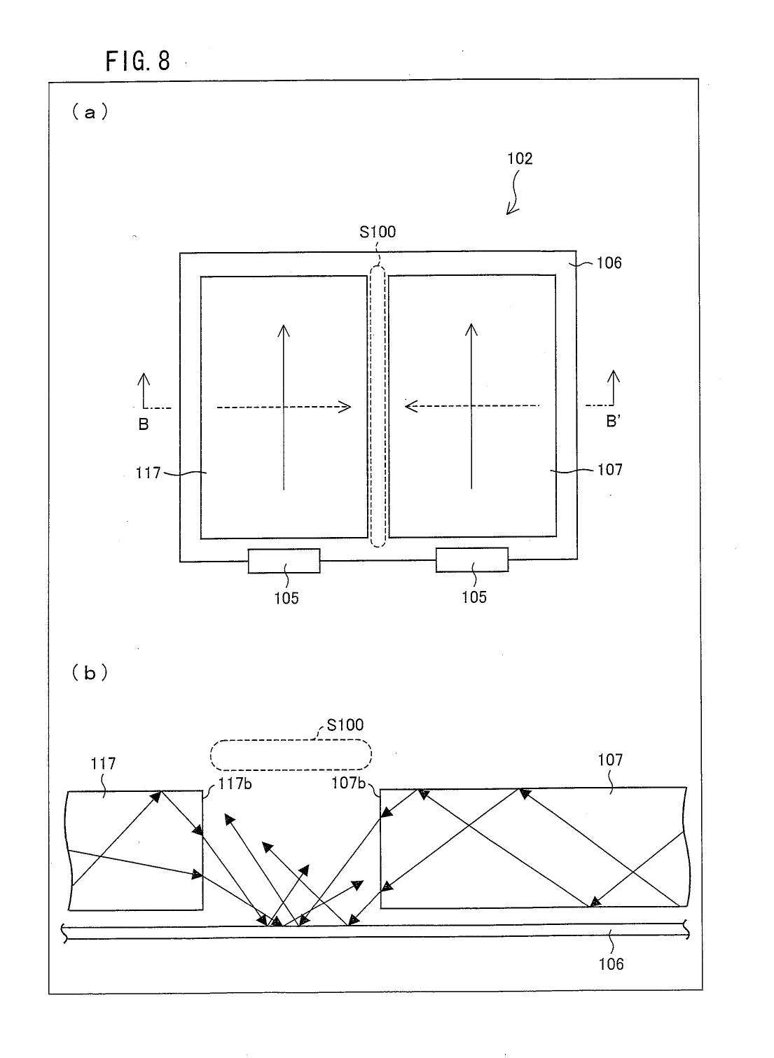

FIG. 8 is a view illustrating a conventional backlight 102. (a) of FIG. 8 is a top view of the backlight 102, and (b) of FIG. 8 is a partial cross-sectional view, viewed along arrows B-B′ in (a) of FIG. 8. For convenience of explanation, members other than a light source, a light guide, and a reflecting material are omitted.

In the conventional backlight 102, most of light emitted from a light source 105 and entering a light guide 107 is guided, in the light guide 107, along a direction (hereinafter also referred to as an optical axis direction; a direction shown by solid-line arrows in (a) of FIG. 8) parallel to a normal direction of a light-irradiation surface of the light source 105. Therefore, an amount of light guided in a direction which is vertical to the optical axis direction and which is parallel to a light emission surface of the light guide 107 (directions shown by broken-line allows in (a) of FIG. 8) is relatively small. Accordingly, an amount of light outputted to a region S100 between the light guide 107 and a light guide 117 is small, so that luminance is decreased in the region S100, thereby resulting in that the luminance of the backlight 102 becomes uneven.

In order to solve such a problem, the backlight 102 is arranged such that a reflecting material 106 is provided in not only a region that faces the light guide 107, but also a region that corresponds to a region between the light guide 107 and the light guide 117. In this case, as illustrated (b) of FIG. 8, light emitted through side surfaces 107b and 117b of the light guides 107 and 117 are partially reflected on a surface of the reflecting material 106 toward a direction of a liquid crystal display panel. This increases luminance in the region S100, thereby restraining an occurrence of luminance unevenness. As a result, it is possible to restrain a decrease of uniformity of luminance of the backlight 102.

However, in the case where the reflecting material 106 is provided as illustrated in (b) of FIG. 8, light beams are totally reflected at given reflecting angles corresponding to respective incident angles on the reflecting material 106. This results in that most of the light beams emitted from one of the light guides are totally reflected on the reflecting material 106 and enter the other one of the light guides. Thus, the light is merely slightly reflected toward the direction of the liquid crystal display panel. Even if the reflecting material 106 is provided as illustrated in (b) of FIG. 8, this is not sufficient to restrain the decrease in uniformity of luminance of the backlight 102.

In contrast, the backlight 2 of the present invention is arranged such that the reflecting material 6 includes a protruding section 20 having a curved surface in a region on a surface, of the reflecting material 6, that faces the light guide 7, which region corresponds to a region between the light guide 7 and the light guide 17 when viewed in a projection manner along a normal direction of the light emission surface 7a. The region in which the protruding section 20 is provided is hereinafter also referred to as “region, in a reflecting material, that corresponds to a region between a light guide and another light guide”. This arrangement restrains the decrease in uniformity of luminance.

[Protruding Section]

Next will be described the protruding section 20 provided in the reflecting material 6.

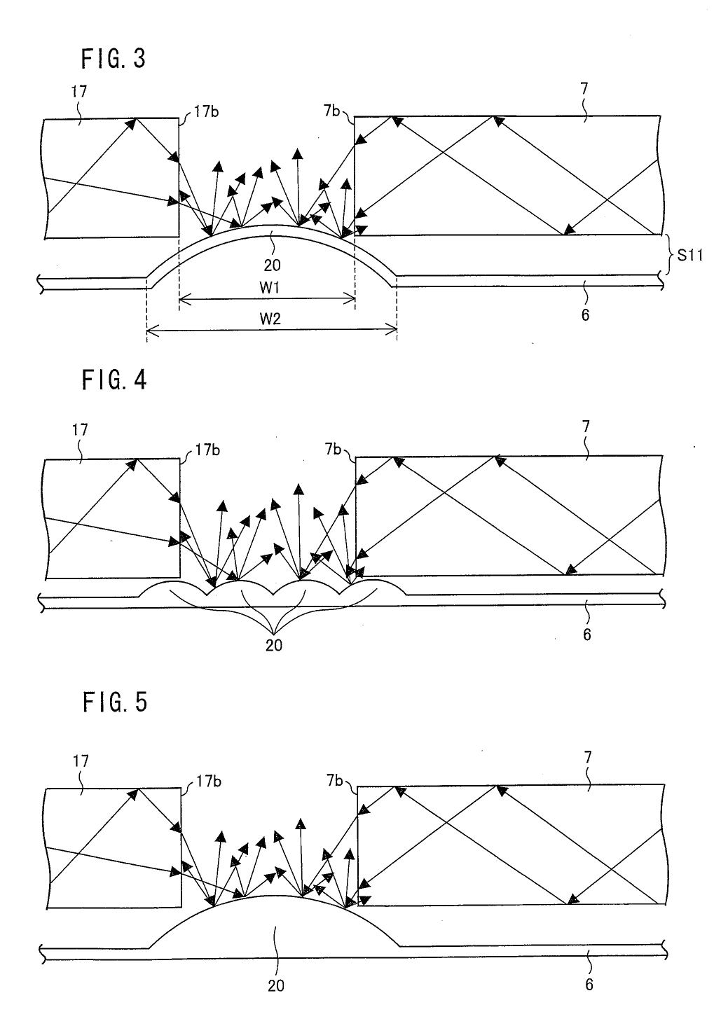

FIG. 3 is a cross-sectional view partially illustrating the backlight 2, viewed along arrows A-A′ in FIG. 2. In FIG. 3, light-traveling directions are shown by arrows.

As illustrated in FIG. 3, in a region, in the reflecting material 6, that corresponds to a region between the light guide 7 and the light guide 17, a protruding section 20 having a arc-shaped contour when viewed in a cross section. When light is incident on the curved surface of the protruding section 20, an outgoing direction of the light is changed. When light emitted through the side surface 7b of the light guide 7 is incident on the curved surface of the protruding section 20, the light is diffused on the curve surface, thereby resulting in that much more light can be caused to travel toward a direction of the liquid crystal display panel 3, as compared with a case where no protruding section 20 is provided. FIG. 7 illustrates directions of emission light. (a) of FIG. 7 illustrates a case where a conventional reflecting material is used having no protruding section, and (b) of FIG. 7 illustrates the arrangement of the present invention in which a protruding section is provided. In FIG. 7, a light beam that is emitted most intensely in incident light is shown by a bold arrow. As illustrated in FIG. 7, when light is diffused by the curved surface of the protruding section 20, the outgoing direction of the most intense emission light is changed, thereby making it possible to supply a more amount of the most intense emission light to the liquid crystal display panel 3 from the region between the light guides. This arrangement makes it possible to further increase the luminance between the light guide 7 and the light guide 17, thereby allowing the backlight 2 to have more improved luminance uniformity.

In order to improve the scattering effect, the protruding section 20 may be further subjected to a surface-roughening process.

As illustrated in FIG. 2, in the present embodiment, the protruding section 20 is a band-like protruding section extending along a direction parallel to the optical axis direction, and has an arc-shaped contour when viewed in a cross section perpendicular to the optical axis direction. The protruding section 20 is provided continuously in a band-like form from one end of the reflecting material 6 to another end of the reflecting material 6. This makes it possible to prevent a decrease in luminance in an entire region sandwiched between the light guide 7 and the light guide 17.

The shape of the protruding section 20 is not limited to the one illustrated in FIG. 3, and may be modified as follows.

FIG. 4 is a cross-sectional view illustrating a modified example of the protruding section 20. In FIG. 4, there are provided four band-like protruding sections 20 arranged in parallel, each of which is narrower in width and lower in height than the band-like protruding section illustrated in FIG. 3. Even in this case, it is also possible to obtain the same effect as the protruding section 20 formed as illustrated in FIG. 3. Further, a degree of light scattering may be changed by changing the number of protruding sections to be formed, thereby making it possible to adjust how much the luminance is increased.

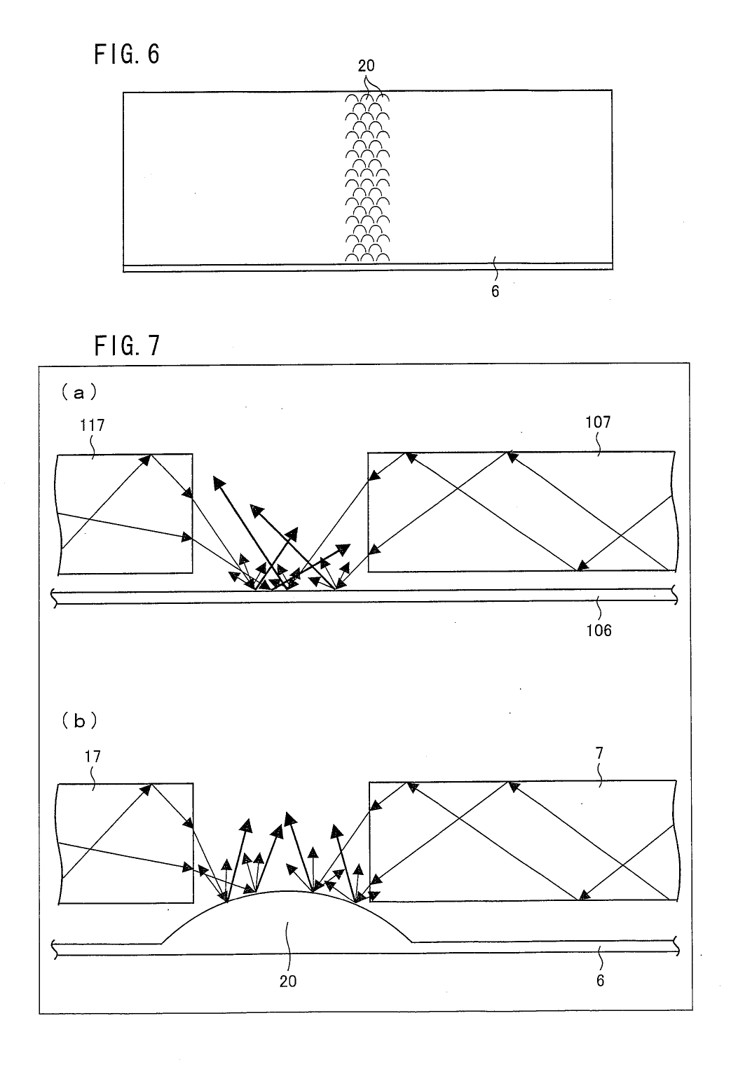

In the present embodiment, the protruding section 20 has a band-like shape, but is not limited to the band-like shape and may be arranged in another form. FIG. 6 is a perspective view illustrating the reflecting material 6 with another modified example of the protruding section 20. As illustrated in FIG. 6, the protruding section 20 may be formed to have a structure in which a plurality of protrusions are provided. In this case, it is preferable that the protrusions be provided all over a region between light-guiding plates to form a band-like shape altogether, so as to prevent the decrease in luminance.

The protruding section 20 may have a curved surface on its side that faces the light guide 7. A structure of a back surface of the protruding section 20 (i.e., a side of the protruding section 20 which side does not face the light guide 7, the liquid crystal display panel 3, and the like; hereinafter referred to as “a backside surface of a reflecting material”) is not limited in any particular manner. For example, in FIG. 3, a plate-like reflecting material is partially curved to form the protruding section 20. When viewed from the backside surface of the reflecting material 6, there is provided a groove having an arc-contour cross section in a region where the protruding section 20 is provided. On the other hand, FIG. 5 is a cross-sectional view illustrating another modified example of the protruding section 20. As illustrated in FIG. 5, the protruding section 20 may be formed such that the backside surface of the reflecting material 6 is planar.

The reflecting material 6 having the protruding section 20 may be produced, for example, such that a mold to be used for forming the reflecting material 6 is processed so that the reflecting material 6 is produced by performing injection molding by use of the mold. In this case, no further material and process are required to form the protruding section 20. In view of this, the present invention is excellent in that it is possible to easily restrain the occurrence of luminance unevenness without any new material more excellent in reflection efficiency and any new process for forming a region excellent in reflection efficiency in order to prevent the occurrence of luminance unevenness.

Further, it is preferable that when viewed in a cross section perpendicular to the optical axis direction, the contour of the protruding section 20 be entirely curved. The shape of the contour may be, for example, an arc, a curve of a polynomial expression of at least second degree, a sine curve, and the like, but is not limited to them.

Further, it is preferable that the protruding section 20 be formed only a region, in the reflecting material 6, that corresponds to a region between the light guide 7 and the light guide 17. That is, it is preferable that no protruding section that does not include a part that overlaps with the region between the light guide 7 and the light guide 17 be formed in the reflecting material 6, when viewed in a projection manner along the normal direction of the light emission surface 7a.

[Arrangement of Reflecting Material]

As illustrated in FIG. 3, the backlight 2 is arranged such that the light guide 7 and the reflecting material 6 are provided so as to form a gap S11 therebetween.

In a case where the gap S11 is formed between the light guide 7 and the reflecting material 6, even if a distance W2 of the protruding section 20 along a direction vertical to the optical axis direction and the normal direction of the light emission surface 7a is longer than a distance W1 between the light guides 7 and 17, it is possible to arrange the light guide 7 and the reflecting material 6 in a preferable manner. In a case where the distance W2 of the protruding section 20 is shorter than the distance W1 between the light guides, the gap 511 may not have to be formed.

An illumination device of the present invention is excellent in luminance uniformity in a case where a plurality of light guides are provided so as to enlarge an area of a light emission surface. In view of this, it is preferable that the illumination device of the present invention be used as a backlight of a liquid crystal display device having an especially large screen. However, the use of the illumination device of the present invention is not limited to this. The illumination device can be used as a backlight of any types of liquid crystal display devices.

As described above, an illumination device of the present invention is arranged such that a protruding section having a curved surface is provided in a region on that surface of a reflecting member that faces light guides, which region corresponds to a region between the light guides adjacent to each other. This yields an effect that an occurrence of luminance unevenness is restrained and an illumination device having improved uniformity of luminance can be realized.

Further, as described above, a liquid crystal display device of the present invention includes an illumination device of the present invention, as a backlight. This makes it advantageously possible to realize a liquid crystal display device excellent in uniformity of luminance.

Here explained is a television device 30 in which a liquid crystal display device 1 of the present invention is used. In the television device 30 of the present invention, a tuner section receives a television broadcast and outputs a video signal, and the liquid crystal display device 1 displays a video image based on the video signal received from the tuner section.

FIG. 9 is an exploded perspective view of the television device 30 using the liquid crystal display device 1. As illustrated in FIG. 9, the television device 30 is arranged such that the liquid crystal display device 1 is sandwiched between a first housing 31 and a second housing 32 so that the liquid crystal display device 1 is enclosed therebetween. The first housing 31 has an opening 31a through which a video image displayed by the liquid crystal display device 1 passes. Further, the second housing 32 covers the backside surface of the liquid crystal display device 1. An operation circuit 33 for operating the liquid crystal display device 1 is provided in the second housing 32, and a support member 34 is attached to a bottom of the second housing 32.

As described above, the television device 30 includes the liquid crystal display device 1 provided with the backlight 2. Accordingly, the television device 30 can display a video image with excellent uniformity of luminance when displaying a video image of a television broadcast.

The present invention is not limited to the description of the embodiments above, but may be altered by a skilled person within the scope of the claims. A proper modification of technical means within the scope of the claims or an embodiment based on proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can provided an illumination device that can emit light from a light source more uniformly. An illumination device of the present invention can be used as a backlight of a liquid crystal display device.

### REFERENCE SIGNS LIST

1 Liquid Crystal Display Device
2 Backlight (Illumination Device)
3 Liquid Crystal Display Panel
5 Light Source
6 Reflecting Member (Reflecting Material)
7, 17 Light Guide
7a Light Emission Surface
7b Side Surface
8 Diffusing Plate
9 Optical Sheet
10 Transparent Plate
20 Protruding Section
102 Backlight
105 Light Source
106 Reflecting Material
107, 117 Light Guide
107b, 117b Side Surface

1. An illumination device comprising:
a light source;
a plurality of light guides for receiving light emitted from the light source and for emitting the light in a plane manner; and
a reflecting member, which is disposed so as to face surfaces of the plurality of light guides which surfaces are opposite to light emission surfaces of the plurality of light guides,
among the plurality of light guides, a first light guide and a second light guide being adjacent to each other,
the reflecting member including at least one protruding section having a curved surface in a region on that surface of the reflecting member which faces the plurality of light guides, which region corresponds to a region between the first light guide and the second light guide when viewed in a projection manner along a normal direction of the light emission surfaces.

2. The illumination device as set forth in claim 1, wherein:
the first light guide and the second light guide are adjacent to each other in a direction which is vertical to an optical axis direction of the light emitted from the light source and which is parallel to the light emission surfaces.

3. The illumination device as set forth in claim 1, wherein:
a surface of the at least one protruding section is curved.

4. The illumination device as set forth in claim 1, wherein:
the at least one protruding section is a band-like protruding section extending in parallel with an optical axis direction of the light emitted from the light source.

5. The illumination device as set forth in claim 1, wherein:
the at least one protruding section has an arc-shaped contour when viewed in a cross section perpendicular to an optical axis direction of the light emitted from the light source.

6. The illumination device as set forth in claim 1, wherein:
the at least one protruding section includes a plurality of protruding sections.

7. The illumination device as set forth in claim 1, wherein:
the plurality of light guides and the reflecting member are spaced apart to form a gap therebetween.

8. A liquid crystal display device comprising an illumination device as set forth in claim 1 as a backlight.

9. A television device comprising a liquid crystal display device as set forth in claim 8.
